(19) United States
(12) Patent Application Publication
(10) Pub. No.: US 2016/0067936 A1
(43) Pub. Date: Mar. 10, 2016

(54) MACHINE AND METHOD FOR FORMING BOXES OF PAPER OR CARDBOARD

(71) Applicant: EMMECI S.P.A., Milano (IT)

(72) Inventors: Mauro MAZZINGHI, Castana (IT); Pablo BARONI, Vicopisano (IT)

(21) Appl. No.: 14/786,697

(22) PCT Filed: Feb. 26, 2014
(86) PCT No.: PCT/IB2014/059268

§ 371 Date: Oct. 23, 2015

(30) Foreign Application Priority Data
May 3, 2013 (IT) BO2013A000197

(51) Int. Cl. B31B 3/72

(52) U.S. Cl. CPC B31B 3/72; B31B 2201/6082; B31B 2203/084

(57) ABSTRACT

A quadrangular machine for forming boxes (1) from blanks (2) having a base and a plurality of segments connected thereto, comprises a die (3) operating on said base; folding elements (4) for folding and setting up said segments to define edges (5) of the box (1); feeders (6) for positioning pieces (7) of heat seal stay tapes to face the edges (5); sealing heads (8) with heatable pressers (9) movable towards and away from the box (1) perpendicularly thereto to press said pieces (7) against the respective edges (5), and with blades (10) which are movable as one with the corresponding presser (9) to cut the stay tapes; each presser (9) comprising a portion (9a) which is movable independently of the blade (10) towards and away from the box (1) to press a portion of the stay tape against the respective edge (5) whilst the blade (10) is at a position of non-interference relative to the stay tape.

### TECHNICAL FIELD

This invention relates to a machine and a method for forming boxes of paper or cardboard from paper or cardboard blanks.

### BACKGROUND ART

The invention relates to the technical field of industrial processing for forming finely finished, quality boxes covered with sheets of covering paper.

The boxes in question are made from specially shaped sheets of paper or cardboard, known as blanks or forming blanks.

More specifically, the boxes are formed from flat forming blanks consisting of a base and a plurality of faces connected to the base and designed to be folded relative to the base to form a lateral wall of the box.

The industrial process leading to the finished box comprises two distinct stages: a stage of forming the box (starting from the forming blank), followed by a stage of covering the box by applying a covering sheet to it.

This invention falls within the context of the stage of forming the box.

Prior art apparatuses which perform the above mentioned box forming stage, generally known as “quadrangular machines” are equipped with a die designed to be coupled to the box in such a way as to move it vertically at a folding station.

At the folding station, these apparatuses comprise folding means (fixed or movable) generally configured to act in conjunction with the die in such a way as to fold the forming blank and to bring the forming blank segments into contact with the lateral wall of the box.

In other words, the folding means fold the blank segments into juxtaposition so that the edges of adjacent segments are juxtaposed to form the vertical edges of the box.

Quadrangular machines are equipped with a plurality of heat sealing heads equipped with heated pressers. The heads are movable relative to the box and configured to apply an adhesive paper tape, or heat seal stay tape, to the vertical edges by pushing the pressers against the respective edges in such a way as to cause the heat seal stay tapes interposed between them to adhere.

Thus, the function of the heat seal stay tape (or heat seal strip) is to keep the adjacent flaps of the forming blank stably together after it has been folded.

The sealing heads are also equipped with blades for cutting the respective pieces of heat seal stay tape at the top ends of them.

Thus, at each vertical edge of the box to be sealed, a piece of heat seal stay tape is unrolled which hangs from the top down. The piece of tape is substantially equal in height to the edge to be sealed.

The piece of heat seal stay tape hangs along a vertical straight line under its own weight and under the action of gravity.

This is very important because if the piece of heat seal stay tape is not perfectly straight when the presser advances into contact with it, the tape is not applied to the box properly, with the result that it is skew, or oblique relative to the edge (not to mention creasing).

This defect tends to reduce the strength of the box and also has a very negative impact on the appearance of the box, even after the box is covered.

This problem is particularly serious in the case of tall boxes, which have very long vertical edges.

This drawback is made worse by the fact that particularly thin, and hence lightweight stay tapes are preferred because they minimize the aesthetic impact of the stay tape under the covering sheet.

One example of a prior art quadrangular machine is described in patent Document EP1609585S1.

This machine, however, is not able to guarantee a good standard of finish, especially in the case of very tall boxes (for example, 150 mm and over).

In light of this, in order to overcome this drawback, patent document BO2011A000265 filed by the same Applicant as this invention provides a solution which consists in making a slight fold (or an incision) along the length of the heat seal stay tape to confer greater bending strength.

This solution, however, involves the risk of damaging the heat seal stay tape.

### DISCLOSURE OF THE INVENTION

This invention has for an aim to provide a machine and a method for forming boxes from paper blanks which overcome the above mentioned drawbacks of the prior art.

More specifically, the aim of this invention is to provide a machine and a method for forming boxes from paper blanks which are particularly accurate and reliable, even in the case of particularly tall boxes (that is, boxes with particularly long lateral edges).

The above mentioned aims are fully achieved by the machine and the method according to the invention as characterized in the appended claims.

More specifically, the invention provides a quadrangular machine for forming boxes from paper or cardboard blanks having a base and a plurality of segments connected to the base, comprising:
a die operating on the base of the blank and movable along a direction of vertical movement;
folding elements configured to interact with the segments of the blank to fold them and set them upright with their lateral sides juxtaposed to define vertical edges of the box;
a plurality of feeders configured to unroll heat seal stay tapes and position pieces of predetermined length of the tapes vertically to face the vertical edges;
a plurality of sealing heads equipped with corresponding pressers which are movable towards and away from the box perpendicularly to the direction of movement to press the pieces of heat seal stay tape against the respective edges, and with corresponding blades which are movable as one with the pressers to cut the heat seal stay tapes.

Note that the expression “die” means generically an element movable vertically and operatively in contact with the base of the box to move and or guide the box in its vertical movement. Preferably, the comprises an element which can be inserted in the box (preferably, but not necessarily, it can be inserted precisely in the box, to occupy substantially its entire internal volume), preferably cooperating with a plate in contact with the lower face of the base of the box.

It should be noted that the pressers are preferably heated (that is to say, they are heatable so that the surface in contact with the heat seal stay tapes is hot).

According to the invention, each of the pressers comprises at least one portion which is movable independently of the corresponding blade. More specifically, the movable portion moves towards and away from the box to press a corresponding portion of the heat seal stay tape against the respective vertical edge, whilst the corresponding blade is at a position of non-interference relative to the heat seal stay tape.

This allows sealing a portion of the tape to a corresponding edge portion of the box, without cutting the tape.

This allows sealing a free bottom end of the heat seal stay tapes to a bottom end of the box edges without cutting the tapes and then unrolling the rest of the tapes for the full length of the edges whilst the box is lowered until the vertical edges face the corresponding pressers along the full length.

That way, when the box is in the lowered position, where the vertical edges do not face the corresponding pressers along their full length and hence the pressers are ready to advance and to seal the entire pieces of heat seal stay tape, these pieces of heat seal stay tape are necessarily positioned vertically and correctly facing the box edges because the fact that the bottom ends of the tapes are already sealed to the bottom zones of the box edges prevents unwanted sideways movements (or bending or misalignment) of the pieces of tape.

In light of this, preferably, (for each sealing head), the movable portion of the presser is positioned at a top end of the presser, proximal to the corresponding blade.

Also, preferably, the movable portion of the presser is motor-driven independently of the motor drive of the presser in its entirety.

This allows moving the entire presser solidly (as one with) the corresponding blade. This is advantageous because it simplifies machine construction.

Preferably (for each sealing head), the movable portion of the presser is connected to the rest of the presser and retractable relative thereto.

Thus, the movable portion of the presser moves solidly with the presser (when the presser is moved, as one with the blade) and is also movable relative to the presser.

The movable portion of the presser defines a surface for contact with the box edge (that is, with the heat seal stay tape). The rest of the presser (that is, the stationary portion of the presser) in turn defines a surface for contact with the box edge.

Preferably, the movable part of the presser and the rest of the presser are subjected to the same machine process to produce these contact surfaces.

This guarantees that when the movable part of the presser is at the retracted position, these contact surfaces are perfectly aligned and form with the presser a smooth and uninterrupted contact surface.

Preferably, the movable portion of the presser consists of a piston formed inside the presser and movable therein to be extracted and retracted relative to the rest of the presser.

Preferably, the pressers are movable between three operating positions:
an advanced position, where the presser acts on the edge of the box;
a retracted position of non-interference relative to the box;
an intermediate position (between the advanced and retracted positions),
   where the selfsame presser and the blade are at a position of non-interference relative to the box and where the movable portion of the presser, when it is positioned in an extracted position relative to the rest of the presser, acts on the corresponding portion of the edge of the box.

In practice, at the intermediate position, the presser is in a “standby” situation, ready to seal the bottom end of the stay tape to the bottom zone of the edge of the box.

This allows the forming process to be speeded up.

Preferably, the quadrangular machine comprises a control unit connected to the feeders to drive them and programmed to stop the feeders after unrolling a first stretch of the pieces.

The control unit is also programmed to re-start the feeders after a pause to unroll a second, remaining stretch of the piece of heat seal stay tape.

During the pause, the movable part of the presser is activated and is extracted from the rest of the presser.

It should be noted that the expression “movable part of the presser” is used to denote an element having the function of a presser and movable independently of the blade which cuts the heat seal stay tape. Indeed, it is clear that the whole of the presser is movable relative to the box but this movement is performed together with the corresponding blade. The movable part of the presser, on the other hand, is further movable also relative to the blade.

It should also be noted that the sealing heads are in turn movable relative to the machine frame to allow preliminary positioning during setup of the machine. This position of the heads is not modified during box forming but only when changing over to forming boxes of a different size.

The invention also provides a method for forming boxes from paper or cardboard blanks having a base and a plurality of segments connected to the base.

The method comprises a step of moving the blank along a direction of vertical movement through the agency of a die coupled to the base of the blank.

More specifically, the die is rested on top of the base and a plate is positioned under the base, which is thus interposed between the die and the plate. During the formation of the box, the die and the plate are moved down vertically.

In light of this, there is a step of folding the blank segments and setting them upright with their lateral sides juxtaposed to define vertical edges of the box.

This folding action is accomplished by the interaction of the blank segments with fixed abutment parts (brushes or folding rollers) during the movement of the blank.

After the folding step, the box is moved down into a sealing station where a plurality of sealing heads operate.

There are as many sealing heads as there are vertical edges to be sealed, that is to say, they are equal in number to the number of sides of the blank base. Usually there are four sealing heads but for the purposes of this invention, there may be any number of sealing heads.

There is also a step of activating plurality of feeders configured to feed pieces of heat seal stay tape of predetermined length (for example by unwinding them from rolls) in such a way that the pieces are positioned vertically to face the vertical edges of the box positioned in the sealing station.

To save time, the step of activating the feeders of the heat seal stay tapes occurs preferably while the box is being moved.

The method further comprises a movement step whereby a plurality of pressers (heated) are moved towards the box perpendicularly to the direction of vertical movement in order to press the pieces of heat seal stay tape against the respective edges.

The pressers are moved together with the corresponding blades to cut the heat seal stay tapes.

This movement step occurs when the box is in the sealing station and the pieces of stay tape have been fed.

According to the invention, the method comprises, for each sealing head, in addition to the steps described above, a step of moving at least one portion of the presser, that portion being movable independently of the corresponding blade. This step of moving the movable portions of the pressers occurs towards the box so as to press a portion of the heat seal stay tape against the respective vertical edge (and then away from it to bring the movable portions back to their retracted, home positions), whilst the corresponding blade is at a position of non-interference relative to the heat seal stay tape.

In other words, according to the invention, there is a further step of heat sealing the portions of heat seal stay tape without cutting the stay tape, in such a way that a portion of each heat seal stay tape is stably joined to a corresponding zone of the box edges without cutting the stay tapes, in particular before the stay tapes are cut to form the pieces.

In effect, this step of moving the movable portions of the pressers occurs before (preliminarily to) the step of moving the pressers together with the respective blades.

In practice, therefore, after the step of folding the blank segments, the box is lowered to an intermediate height between the height of a folding station (where the folding elements operate) and the sealing station.

Thus, the box is made to pause at a pre-sealing station, located at a height above the sealing station (but below the folding station).

At the pre-sealing station, the bottom zones (close to the bottom ends) of the lateral edges of the box are facing the movable portions of the pressers (situated under, and in the proximity of, the blades).

At the same time, the feeders unroll portions of stay tape which are shorter than the pieces of stay tape, that is to say, shorter than the length of the vertical edges of the box. More specifically, the feeders feed the heat seal stay tapes until the free ends (the bottom ends) of the stay tapes face the movable portions of the pressers (thus being interposed between the selfsame movable portions of the pressers and the aforementioned bottom zones of the vertical edges of the box).

Then, (during this pause), the movable portions of the pressers are extracted and then retracted (without causing the blades to come into action) to seal the free ends (the bottom ends) of the heat seal stay tapes to the bottom zones of the vertical edges of the box, without the stay tapes being cut.

Next, the box is lowered into the sealing station. At the same time, further portions of heat seal stay tape are unrolled.

In effect, during the movement of the box from the pre-sealing station to the sealing station, the ends of the stay tapes are already sealed to the box and thus the stay tapes cannot undergo any unwanted movement or deformation.

In light of this, the feeders of the heat seal stay tapes are in-phase synchronized by a control unit relative to the movement of the box (that is, of the die).

For example, after the die has paused at the pre-sealing station and while the die is being lowered to the sealing station, the feeders are activated to unroll and feed further portions of the stay tapes.

In this case, the action of the feeders is coordinated by a control unit in phase synchronization with the movement of the box (that is, of the die) in order to prevent the heat seal stay tapes from becoming too taut or too slack. Preferably, the feeders are activated slightly in advance of the lowering of the box, so as to prevent undue mechanical stress from being applied to the stay tapes.

In another embodiment, during the movement of the box from the pre-sealing station to the sealing station, the feeders passively allow the stay tapes to be unrolled by the pulling action applied by the box on the ends of the stay tapes sealed thereto as it moves down.

In this case, the control unit disables the feeders in order to allow the heat seal stay tapes (that is, the rolls of heat seal stay tape) to turn freely while the box is being moved from the pre-sealing station to the sealing station.

In light of this, the control unit is preferably configured to disable the feeders when the box is at the pre-sealing station. Preferably, the feeders are disabled by disconnecting the rolls of heat seal stay tape from the respective drive systems.

In this case, the control unit is programmed to re-enable the feeders after the box has reached the sealing station so as to prepare the machine to seal another box.

It should be noted that in this embodiment, the feeders can be controlled in such a way as to unroll only a first stretch of heat seal stay tape, shorter in length than the height of the box edges, because the remaining stretch is unrolled by the dragging action applied by the box on the stay tapes.

The step of moving the pressers to seal the vertical edges of the box in their entirety is carried out at the sealing station.

During this step, the movable parts of the pressers still move but in this case, their movement occurs as one with the remaining parts of the presser and with the corresponding blades.

Preferably, therefore, in the downward movement of the die (and hence of the box) and after the folding step, the method comprises a pause of the die at a position where the bottom end of the die (and hence of the box) is positioned at the height of the movable portion of each presser, the movable portion of the pressers being positioned close to a top end of the pressers proximal to the corresponding blades.

Preferably, the feeders unroll the pieces of heat seal stay tape in two distinct feed sub-steps performed before and after the box (that is, the die) pauses at the pre-sealing station.

More specifically, the feed sub-steps comprise:
(in a first feed sub-step) feeding (preferably by unrolling) a first stretch of heat seal stay tape in such a way that the free end of the stay tape is aligned with the movable portions of the pressers so that the movable portion of the pressers can seal the free end of the stay tapes to a bottom zone of the edges of the box (when the die pauses);
(in a second feed sub-step) feeding (preferably by unrolling) a second (remaining) stretch of heat seal stay tape (hence, after the free ends of the stay tapes have been sealed), simultaneously with a further downward movement of the die, after which the vertical edges of the box are fully facing the corresponding pressers.

Preferably, the pressers are moved towards and away from the box between three operating positions. More specifically, these operating positions of the pressers (in their entirety, including the blades integral therewith) comprise:
a spaced apart position to allow the formed box to move upwards out of the machine;
a close together position where the pressers act on the corresponding vertical edges of the box when the box is at a lowered position where the vertical edges of the box are completely facing the corresponding pressers (that is, when the box is at the sealing station);
an intermediate position between the spaced-apart and the close-together positions, where the pressers are located when the bottom end of the die is at the height of the movable portions of the pressers (that is, when the box is at the pre-sealing station).

It should be noted that the machine is preferably provided with a control to enable and disable the movement of the movable portion of the presser (relative to the rest of the presser).

This control is connected to the control unit and works as follows.

If the function of moving the movable portion of the presser is enabled, the operation of the machine is that described above.

If the function of moving the movable portion of the presser is disabled, the operation of the machine is like that of a traditional machine, that is, the movable part of the presser is kept at the retracted position and the die is moved directly into the sealing station, without the additional pause at the pre-forming station.

The possibility of disabling the function of separately moving the movable portion of the presser is important because it allows the machine to work faster whenever the box to be formed is not particularly tall and the function of separately moving the movable portion of the presser does not need to enabled.

It should also be noted that the concept this invention is based on is to configure the machine in such a way as to allow sealing a portion of heat seal stay tape to a corresponding portion of the box edge without cutting the stay tape.

This result might also be achieved by making the blades movable between two working positions, an extracted position (traditional) where they cut the heat seal stay tape when the presser is advanced and pressed against the edge of the box, and a retracted position where the blade is at a position of non-interference with the box even when the presser (and the blade mounted thereon) is advanced and pressed against the edge of the box.

In the example embodiment illustrated, on the other hand, it is the presser (or rather, at least a part of the presser) that is movable between two positions relative to the blade, but without this example being considered as limiting the scope of the invention.

### BRIEF DESCRIPTION OF DRAWINGS

These and other features of the invention will become more apparent from the following detailed description of a preferred, non-limiting embodiment of it, illustrated in the accompanying drawings, in which

FIG. 1 is a perspective view showing a machine and a method according to this invention for forming boxes of paper or cardboard from blanks made of paper or cardboard;

FIG. 2 is a perspective view showing a stay tape sealing head forming part of the machine of FIG. 1;

FIG. 3 illustrates the sealing head of FIG. 2 in a side view with some parts in cross section in order to better illustrate certain details;

FIG. 4 is an exploded perspective view of a scaled up detail from FIG. 3, showing in particular a cutting blade mounted on a sealing head;

FIGS. 5 and 6 illustrate a pair of sealing heads in a corresponding succession of steps of sealing the edges of the box; both of the figures are schematic side views.

### DETAILED DESCRIPTION OF PREFERRED EMBODIMENTS OF THE INVENTION

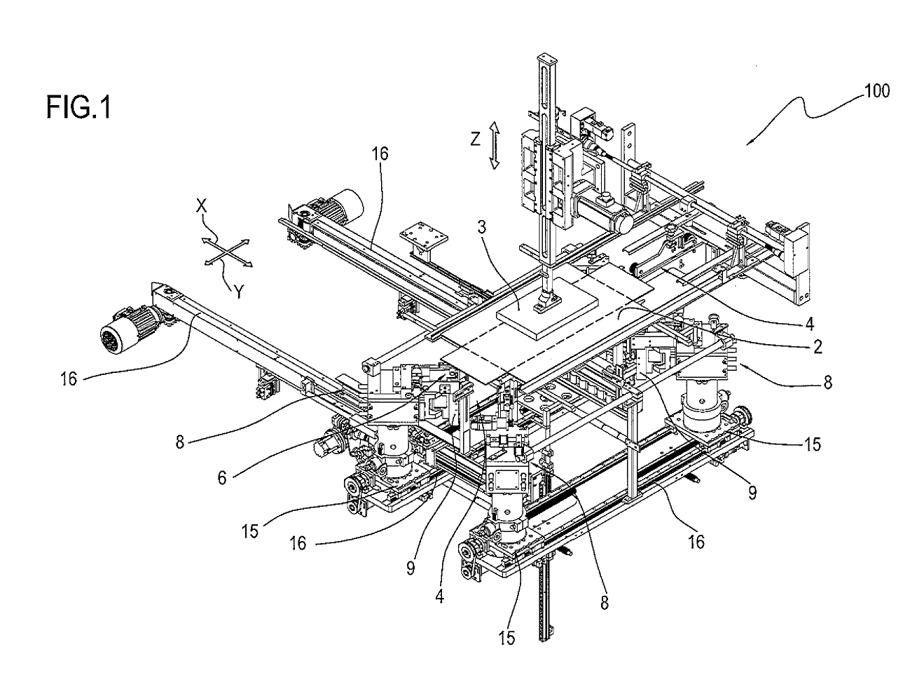

With reference to the accompanying drawings, in particular FIG. 1, the machine of the invention, of the quadrangular type and labelled 100, is used to make boxes 1 of paper or cardboard.

More specifically, the machine 100 forms boxes 1 from paper or cardboard blanks 2 having a base and a plurality of segments connected to the base.

The machine 100 comprises a die 3 operating on the base of the blank 2 and movable along a direction Z of vertical movement.

More specifically, the die 3 is rested on top of the base of the blank 2, whilst a plate 3a is positioned under the base of the blank 2, which is thus interposed between the die 3 and the plate 3a.

During the formation of the box 1, the die 3 and the plate 3a are moved down vertically.

The machine 100 also comprises folding elements 4 configured to interact with the segments of the blank 2 to fold them and set them upright with their lateral sides juxtaposed to define vertical edges 5 of the box 1.

More specifically, the folding of the segments of the blank 2 to set them upright with their lateral sides juxtaposed to define vertical edges 5 of the box is accomplished by the interaction of the segments of the blank 2 with fixed abutment parts (brushes or folding rollers, not illustrated in full since they do not form part of the invention) during the movement of the blank 2.

The machine 100 also comprises a plurality of feeders 6 configured to unroll heat seal stay tapes and position pieces 7 of predetermined length of the stay tapes vertically to face the vertical edges 5 of the box 1.

The machine 100 comprises a plurality of sealing heads 8 equipped with corresponding pressers 9, which are heatable and movable towards and away from the box 1 perpendicularly to the direction Z of movement to press the pieces 7 of heat seal stay tape against the respective edges 5, and with corresponding blades 10 which are movable as one with the pressers 9 to cut the heat seal stay tapes.

Each sealing head 8 is associated with a respective motor-driven supporting carriage 15 mounted on horizontal guides 16.

Each carriage 15 is configured to move the sealing head 8 along two axes X and Y, perpendicular to each other, so as to be able to adjust the position of the head 8 according to the size of the box 1 to be formed. In other words, each sealing head 8 is adjustable according to the size of the box 1 to be formed. This adjustment movement is performed at the start of the cycle for that size of box 1, after which the heads remain stationary at their working positions.

There are as many sealing heads 8 as there are vertical edges 5 of the box 1 to be sealed, that is to say, they are equal in number to the number of sides of the base of the blank 2.

Usually there are four sealing heads 8 but for the purposes of this invention, there may be any number of sealing heads.

Each blank 2 forming the box 1 is fed from above the sealing heads 8 and above a work space delimited by the folders 4 and by the selfsame sealing heads 8.

It should be noted that each sealing head 8 defines an operating unit comprising the heatable presser 9, the blade 10 for cutting the piece 7 of stay tape and the stay tape feeders 6.

In light of this, the presser 9 has a profile for contact with the edge 5 of the box 1 which is adapted to fit the shape of the edge 5.

In the operating unit of each sealing head 8 the stay tape feeders 6 are located above the pressers 9.

Each feeder 6 comprises a stay tape feed track 17 which is configured to guide the stay tape in a direction N along a first stretch of path running transversely to the vertical direction Z and along a second stretch running parallel to the vertical direction Z.

The first stretch of path is delimited by two vertical walls 18, whilst the second stretch of path is defined by two stay tape feed rollers 19 and 20 (one of which is motor-driven) and by a vertical opposing wall 21 designed to allow a guided change of direction of the stay tape in a vertical plane parallel to the pressers 9.

The blade 10 is interposed between the stay tape feeders 6 and the presser 9.

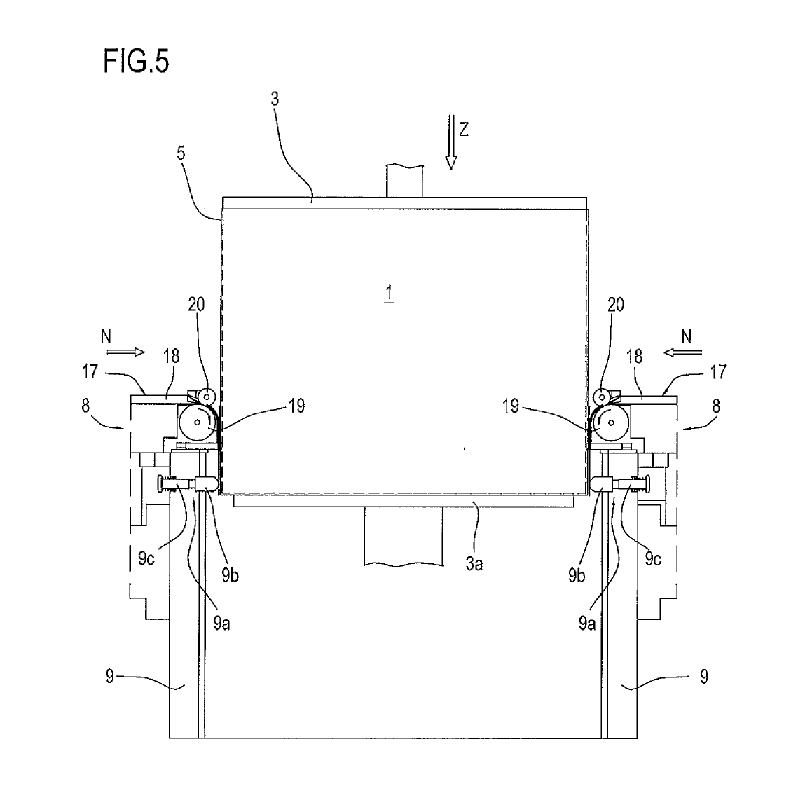

More specifically (as illustrated, for example, in FIG. 4), the blade 10 comprises a fixed portion 10a (meaning by that, fixed relative to the sealing head 8, that is to say, stationary relative to the sealing head 8) and a portion 10b associated with the presser 9 and movable as one with the presser 9.

The fixed portion 10a consists of a frame with a closed end shaped to form two lobes through which the stay tape runs transversely while it is being fed.

The movable portion 10b is a plate-like knife which has a front cutting edge and which is slidable with the presser 9.

The knife 10b is moved by the presser 9 but remains guided during its movement thanks to a support 10c fixed to the body of the sealing head 8.

The V-shaped front profile of the knife 10b is substantially shaped to match the shaped end of the frame 10a so as to intercept the stay tape during the forward movement of the presser 9 and to cut the stay tape thanks to the opposing action of the frame 10a.

According to the invention, each of the pressers 9 comprises at least one portion 9a which is movable independently of the corresponding blade 10 towards and away from the box 1 to press a corresponding portion of the heat seal stay tape against the respective vertical edge 5 whilst the corresponding blade 10 is at a position of non-interference relative to the heat seal stay tape.

The movable portion 9a of the presser allows sealing a portion of the stay tape to a corresponding portion of the box edge 5 without cutting the stay tape fed until that moment.

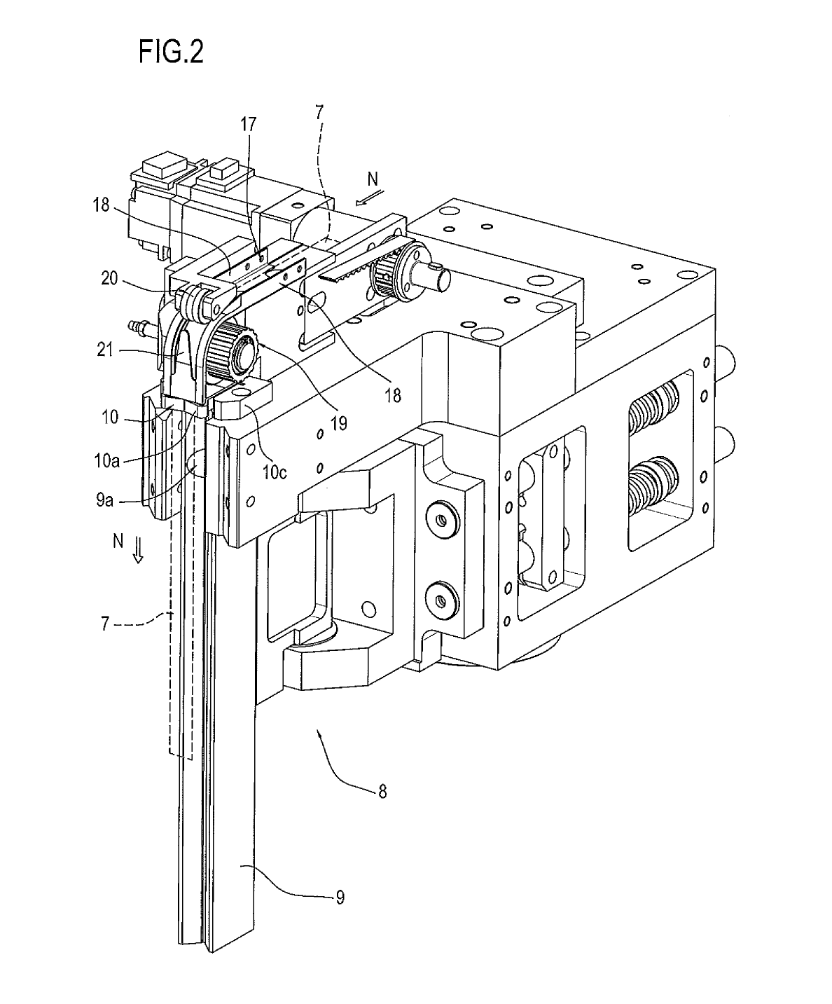

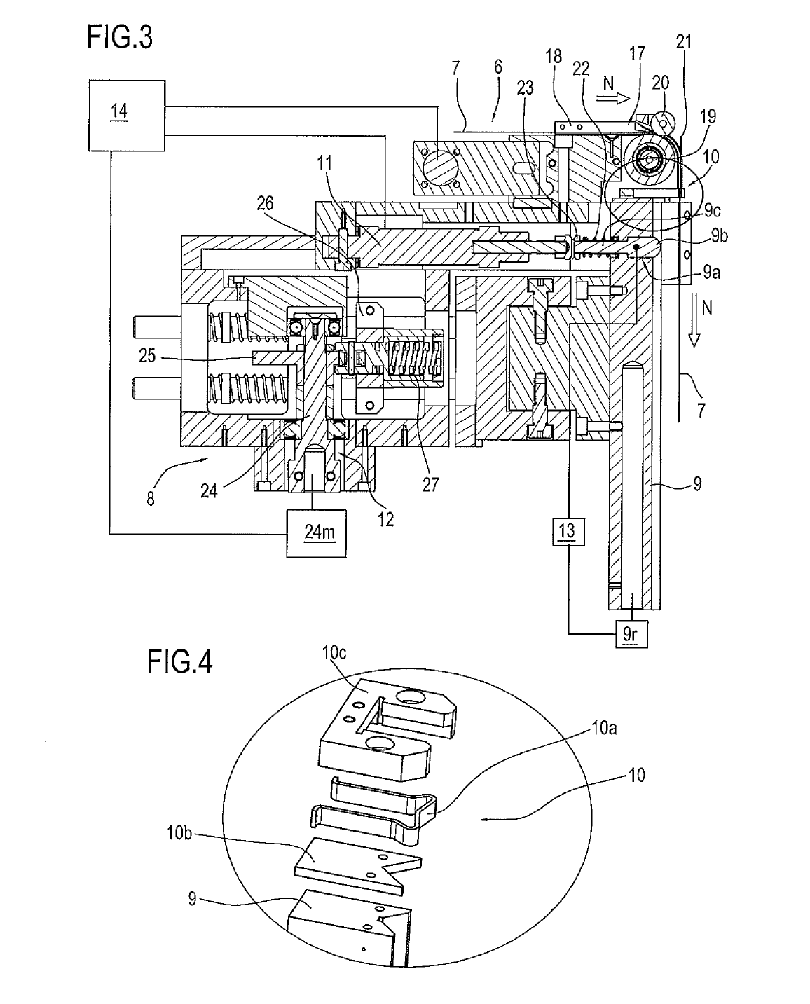

Preferably, the movable portion 9a of the presser 9 is positioned at a top end of the presser 9, proximal to the corresponding blade 10 (see FIGS. 2 and 3).

In light of this, each sealing head 8 comprises an actuator 11 connected to the movable portion 9a of the presser 9.

The sealing head 8 comprises a motor drive 12 configured to move the entire presser 9 and the corresponding blade 10 integral therewith. It should be noted that the actuator 11 can be driven independently of the motor drive 12.

In light of this, each movable portion 9a of the presser 9 is composed of a piston divided into a contact head 9b and a stem 9c.

Fitted around the stem 9c there is an elastic element 22 held at the ends of it by an abutment ring 23 located at the distal end of the stem 9c (relative to the head 9b) and by the inside surface of the presser 9.

The elastic element 22 keeps the movable portion 9a at a non-operating retracted position with its operating contact surface aligned with the remaining operating contact surface of the presser 9.

In light of this, the distal end of the stem 9c is in contact with the actuator 11, which is positioned in a first chamber of the operating unit of the sealing heads 8 and also associated with the motor drive 12 of the presser 9.

The actuator 11 is activated, during the operating cycle, to push the stem 9c in such a way as to allow extraction of the contact head 9b in order to seal the stay tape to the vertical edge 5 of the box 1: the actuator 11 is activated independently of the motor drive 12.

In light of this, each movable portion 9a of the presser 9 defines a surface for contact with the edge 5 of the box 1: this surface is movable between an extracted position, where it is operatively in contact with the edge 5, whilst the blade 10 and a remaining, stationary part of the presser 9 is at a position of non-interference, and a retracted position, where it is aligned with a contact surface defined by the stationary part of the presser 9 to form with the stationary part an uninterrupted contact surface of the presser 9.

In light of this, the contact surface of each movable portion 9a of the presser 9 is surrounded by the corresponding contact surface of the stationary portion of the presser 9 (see FIG. 2).

It should also be noted that each movable portion 9a of the presser 9 is connected to the rest of the presser 9 and retractable relative thereto.

Preferably, to obtain these features, the movable part 9a of each presser (in particular, the contact head 9b) and the rest of the presser 9 are subjected to the same machine process to produce these contact surfaces.

This guarantees that when the movable part 9a of the presser 9 is at the retracted position, the contact surfaces are perfectly aligned and form with the selfsame presser 9 a smooth and uninterrupted contact surface.

Preferably, as stated above, each movable portion 9a of the presser consists of a piston formed inside the presser 9 and movable therein to be extracted and retracted relative to the rest of the presser 9.

Each actuator 11 of the movable part 9a of the presser 9 is associated with the motor drive 12 of the entire presser 9.

In light of this, each motor drive 12 preferably consists of a shaft 24 driven by a motor 24m on which there is keyed a circular cam profile 25 (the drive motor 24m of the shaft 24 is schematically represented as a block in FIG. 3).

The shaft 24 is rotatable about a vertical axis 12x in such a way as to allow the cam profile 25 to rotate.

The cam profile 25 moves a carriage 26 radially in both directions to advance and withdraw it (relative to the edge 5 of the box 1), a carriage supporting the presser 9 and the movable portion 9a, and also having the blade 10 associated with it.

Each carriage 26 is equipped with elastic elements 27 which are axially parallel to the advancing and withdrawing directions of the presser 9 to act in conjunction with the cam 25 to withdraw the carriage 26.

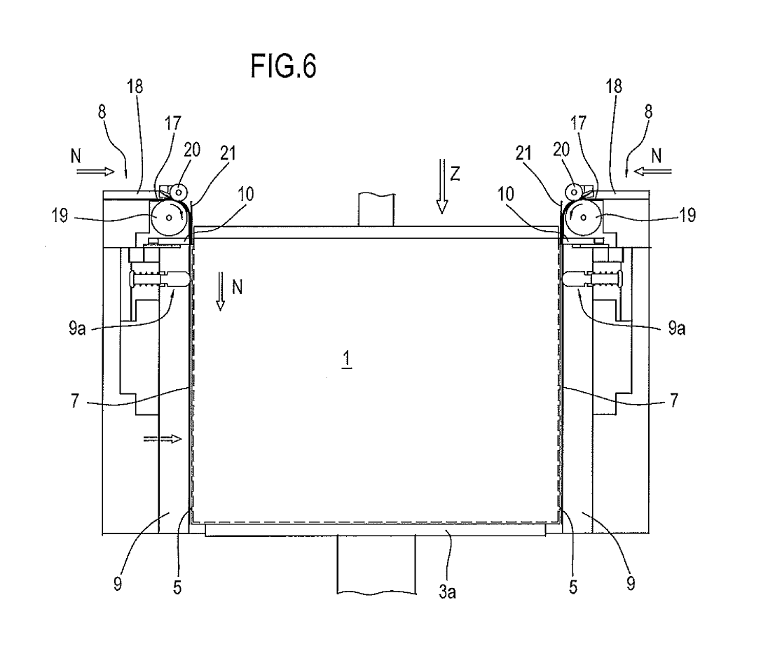

Thanks to this structure, each presser 9 is movable towards and away from the box 1 between the following three operating positions:
an advanced position, where it acts on the edge 5 of the box 1 (FIG. 6);
a retracted position of non-interference relative to the box 1;
an intermediate position, where the selfsame presser 9 and the blade 10 are at a position of non-interference relative to the box 1 and where the movable portion 9a of the presser 9, at an extracted position relative to the rest of the presser, acts on the corresponding portion of the edge 5 of the box 1 (FIG. 5).

In other words, at the intermediate position, the presser 9 is in a “standby” situation, ready to seal the bottom end of the stay tape to the bottom zone of the edge 5 of the box 1.

This allows the forming process to be speeded up.

Preferably, the movable portion 9a of the presser 9 is hollow and houses a heater 13 (structurally independent but connected to the heaters 9R of the corresponding presser 9).

The machine 100 comprises a control unit 14 connected to the feeders 6 to drive them and programmed to stop the feeders 6 after unrolling a first stretch of the pieces 7 and to re-start the feeders 6 after a pause to unroll a second, remaining stretch of the piece 7 of heat seal stay tape.

During this pause, the movable part 9a of the presser 9 is activated and is extracted from the rest of the presser 9.

The control unit 14 is connected to the motor-driven roller 19 to stop and re-start stay tape feed.

The control unit 14 is connected to the actuator 11 and to the motor drive 12 so that stay tape feed, activation of the actuator 11 and activation of the motor drive 12 are coordinated in phase synchronization.

Preferably, the control unit 14 drives the feeders 6 in such a way as to activate them slightly in advance of the lowering of the box 1, so as to prevent undue mechanical stress from being applied to the stay tapes. It should be noted that it is also possible (through the control unit 14) to disable the movable portion 9a of the presser 9, that is to say, to disable the supplementary pre-sealing function.

In this case, the sealing head 8 operates in “traditional” mode, which means the machine 100 pauses one time less and is therefore faster: this function can be disabled when the boxes to be formed have short edges (that is, when the boxes are not very tall).

It should also be noted that the expression “movable part 9a of the presser 9” is used to denote an element having the function of a presser and movable independently of the blade 10 which cuts the heat seal stay tape.

From the foregoing, it is clear that the whole of the presser 9 is movable relative to the box 1 but this movement is performed together with the corresponding blade 10.

The movable part 9a of the presser 9, on the other hand, is further movable also relative to the blade 10.

It should also be noted that the sealing heads 8 are in turn movable relative to the frame of the machine 100 (not shown in the drawings) to allow preliminary positioning during setup of the machine 100.

This position of the heads 8 is not modified during the forming of a box 1 (as mentioned above) but only when changing over to forming boxes of a different size.

The invention also provides a method for forming boxes 1 from paper or cardboard blanks 2 having a base and a plurality of segments connected to the base. The method comprises the following steps (see FIGS. 5 and 6):
moving the blank 2 along a direction Z of vertical movement through the agency of a die 3 coupled to the base of the blank 2;
folding the segments of the blank 2 and setting them upright with their lateral sides juxtaposed to define vertical edges 5 of the box 1;
activating a plurality of feeders 6 configured to unroll heat seal stay tapes and position pieces 7 of predetermined length of the stay tapes vertically to face the vertical edges 5;
moving a plurality of heated pressers 9 which are movable towards the box 1 perpendicularly to the direction Z of movement to press the pieces 7 of heat seal stay tape against the respective edges 5, and moving corresponding blades 10 together with the pressers 9 to cut the heat seal stay tapes.

According to the invention, the step of moving the pressers 9 together with the corresponding blades 10 is preceded by a step of advancing a plurality of movable portions 9a of the pressers 9, independently of the corresponding blades 10, towards the box 1 in order to press a corresponding portion of heat seal stay tape against the respective vertical edge 5, while the corresponding blade 10 is at a position of non-interference relative to the heat seal stay tape.

In other words, there is a further step of heat sealing portions of heat seal stay tape without cutting the stay tape, in such a way that a portion of each heat seal stay tape is stably joined to a corresponding zone of the edges 5 of the box 1 without cutting the stay tapes.

This is done, in particular, before the stay tapes are cut to form the pieces 7.

The aforementioned step of moving the movable portions 9a of the pressers 9 occurs before the step of moving the pressers 9 together with the respective blades 10.

In practice, therefore, after the step of folding the blank segments, the box 1 is lowered to an intermediate height between the height of a folding station (where the folding elements operate) and the sealing station.

It should be noted that the box 1 is made to pause at a pre-sealing station, located at a height above the sealing station (but below the folding station).

At the pre-sealing station, the bottom zones (close to the bottom ends) of the lateral edges 5 of the box 1 are facing the movable portions 9a of the pressers 9 (situated under, and in the proximity of, the blades 10).

At the same time, the feeders unroll portions of stay tape which are shorter than the pieces 7 of stay tape, that is to say, shorter than the length of the vertical edges 5 of the box 1.

More specifically, the feeders feed the heat seal stay tapes until the free ends (the bottom ends) of the stay tapes face the movable portions 9a of the pressers 9.

During this intermediate pause, the movable portions 9a of the pressers 9 are extracted and then retracted (without causing the blades 10 to come into action) to seal the free ends (the bottom ends) of the heat seal stay tapes to the bottom zones of the vertical edges 5 of the box 1, without the stay tapes being cut.

In light of this, in the downward movement of the die 3 and after the folding step, the die 3 pauses at a position where the bottom end of the die 3 is positioned at the height of the movable portion 9a of each presser 9.

The movable portions 9a of the pressers 9 are positioned at the top ends of the pressers 9, proximal to the corresponding blades 10.

Thanks to this feature, during the movement of the box 1 from the pre-sealing station to the sealing station, the ends of the stay tapes are already sealed to the box 1 and thus the stay tapes cannot undergo any unwanted movement or deformation.

Preferably, the feeders 6 unroll the pieces 7 of heat seal stay tape in two successive steps:
a first stretch of heat seal stay tape is unrolled in such a way that the free end of the stay tape is aligned with the movable portion 9a of each presser 9 so that the movable portion 9a of each presser 9 can seal the free end of each stay tape to a bottom zone of the respective edge 5 of the box 1 when the die 3 pauses (FIG. 5);
a second, remaining stretch of heat seal stay tape is unrolled after the free ends of the stay tapes have been sealed, simultaneously with a further downward movement of the die 3, after which the vertical edges 5 of the box 1 are fully facing the corresponding pressers 9 (FIG. 6).

In light of this, the pressers 9 are moved towards and away from the box 1 between
a spaced apart position to allow the formed box 1 to move upwards out of the machine 100;
a close together position where the pressers 9 act on the corresponding vertical edges 5 of the box when the box 1 is at a lowered position where the vertical edges 5 of the box 1 are completely facing the corresponding pressers 9 (FIG. 6);
an intermediate position between the spaced-apart and the close-together positions, where the pressers 9 are located when the bottom end of the die 3 is at the height of the movable portions 9a of the pressers 9 (FIG. 5).

The machine structured in this way achieves the set aims thanks to the movable portion 9a of the presser 9 which can move independently of the rest of the presser 9, and thus independently of the blade 10.

This offers several advantages, including the following:
greater precision in applying the piece of stay tape to the box edge perfectly straight and without creasing;
greater box strength (especially in the case of boxes with particularly long edges);
improved appearance after the box is covered thanks to the possibility of using particularly thin and lightweight heat seal stay tapes without any risk.

1. A quadrangular machine for forming boxes from paper or cardboard blanks having a base and a plurality of segments connected to the base, comprising:
a die operating on the base of the blank and movable along a direction of vertical movement;
folding elements configured to interact with the segments of the blank to fold them and set them upright with their lateral sides juxtaposed to define vertical edges of the box;
a plurality of feeders configured to unroll heat seal stay tapes and position pieces of predetermined length of the stay tapes vertically to face the vertical edges;
a plurality of sealing heads equipped with corresponding pressers, which are heatable and movable towards and away from the box perpendicularly to the direction of movement to press the pieces of heat seal stay tape against the respective edges, and with corresponding blades which are movable as one with the pressers to cut the heat seal stay tapes,
wherein each of the pressers comprises at least one portion which is movable independently of the corresponding blade towards and away from the box to press a corresponding portion of the heat seal stay tape against the respective vertical edge whilst the corresponding blade is at a position of non-interference relative to the heat seal stay tape.

2. The machine according to claim 1, wherein the movable portion of the presser is positioned close to a top end of the presser, proximal to the corresponding blade.

3. The machine according to claim 1, comprising an actuator connected to the movable portion of the presser and a motor drive configured to move the entire presser and the corresponding blade, wherein the actuator can be driven independently of the motor drive.

4. The machine according to claim 1, wherein the movable portion of the presser defines a surface for contact with the edge of the box, and wherein that surface is movable between an extracted position, where it is operatively in contact with the edge, whilst the blade and a remaining, stationary part of the presser is at a position of non-interference, and a retracted position, where it is aligned with a contact surface defined by the stationary part of the presser to form with the stationary part a smooth and uninterrupted contact surface of the presser.

5. The machine according to claim 4, wherein the contact surface of each movable portion of the presser is surrounded by the corresponding contact surface of the stationary portion of the presser.

6. The machine according to claim 1, wherein the movable portion of the presser is connected to the rest of the presser and retractable relative thereto.

7. The machine according to claim 6, wherein the presser is movable towards and away from the box between the following three operating positions:
an advanced position, where it acts on the edge of the box;
a retracted position of non-interference relative to the box;
an intermediate position, where the selfsame presser and the blade are at a position of non-interference relative to the box and where the movable portion of the presser, at an extracted position relative to the rest of the presser, acts on the corresponding portion of the edge of the box.

8. The machine according to claim 1, wherein the movable portion of the presser is hollow and houses a heater.

9. The machine according to claim 1, comprising a control unit connected to the feeders to drive them and programmed to stop the feeders after unrolling a first stretch of the pieces and to keep the feeders disabled during a downward movement of the box to allow unrolling of a remaining stretch of the pieces thanks to the pulling action applied by the box on the heat seal stay tapes which are held in place by the portions of heat seal stay tape which are already sealed to the respective edges by the movable portions of the pressers, or to re-start the feeders after a pause to unroll a second, remaining stretch of the piece of heat seal stay tape.

10. A method for forming boxes from paper or cardboard blanks having a base and a plurality of segments connected to the base, comprising the following steps:
moving the blank along a direction of vertical movement through the agency of a die coupled to the base of the blank;
folding the segments of the blank and setting them upright with their lateral sides juxtaposed to define vertical edges of the box;
activating a plurality of feeders configured to unroll heat seal stay tapes and position pieces of predetermined length of the stay tapes vertically to face the vertical edges;
moving a plurality of heated pressers towards the box perpendicularly to the direction of movement to press the pieces of heat seal stay tape against the respective edges, and moving corresponding blades together with the pressers to cut the heat seal stay tapes;
wherein it comprises, before the step of moving the pressers together with the respective blades, a step of advancing a plurality of movable portions of the pressers towards the box independently of the corresponding blades in order to press a corresponding portion of heat seal stay tape against the respective vertical edge while the corresponding blade is at a position of non-interference relative to the heat seal stay tape.

11. The method according to claim 10, comprising, in a downward movement of the die and after the folding step, a step of pausing the die at a position where the bottom end of the die is positioned at the height of the movable portions of the pressers, the movable portion of each presser being positioned close to a top end of the presser, proximal to the corresponding blade.

12. The method according to claim 11, wherein the pieces of heat seal stay tape are unrolled in two successive steps:
a first stretch of heat seal stay tape is unrolled in such a way that the free end of the stay tape is aligned with the movable portions of the pressers so that the movable portion of each presser can seal the free end of each stay tape to a bottom zone of the respective edge of the box during the pause of the die, the first stretch of heat seal stay tape being unrolled by the feeders;
a second, remaining stretch of heat seal stay tape is unrolled after the free ends of the stay tapes have been sealed, simultaneously with a further downward movement of the die, after which the vertical edges of the box are fully facing the corresponding pressers, this remaining stretch of heat seal stay tape being unrolled by the box itself as it moves down and thereby applies a pulling action on the stay tapes once the feeders have been disabled after the free ends of the stay tape have been sealed and before the further downward movement of the die, or by the feeders, driven in phase synchronization with the movement of the box during the further downward movement of the die.

13. The method according to claim 12, wherein the pressers are moved towards and away from the box between
a spaced apart position to allow the formed box to move upwards out of the machine;
a close together position where the pressers act on the corresponding vertical edges of the box when the box is at a lowered position where the vertical edges of the box are completely facing the corresponding pressers;
an intermediate position between the spaced-apart and the close-together positions, where the pressers are located when the bottom end of the die is at the height of the movable portions of the pressers.
